(19) United States
(12) Patent Application Publication
(10) Pub. No.: US 2012/0111690 A1
(43) Pub. Date: May 10, 2012

(54) ELECTROMAGNETIC CLUTCH

(76) Inventors: Yoshihiro Kurosu, Gunma (JP); Haruhiko Ushirode, Gunma (JP)

(21) Appl. No.: 13/288,879

(22) Filed: Nov. 3, 2011

(30) Foreign Application Priority Data
Nov. 5, 2010 (JP) 248302/2010

(51) Int. Cl. F16D 27/04

(52) U.S. Cl. 192/84.9

(57) ABSTRACT

An electromagnetic clutch including a driving rotating body, driven rotating body, armature, and field core. The driving rotating body receives power transmitted from a driving device via a driving power transmission member. The driven rotating body is arranged coaxially with the driving rotating body, and mounted on a driven device to rotate integrally with the driven device. The armature is opposed to the end face of the driving rotating body in the axial direction, and supported by the driven rotating body via spring members to integrally rotate with the driven rotating body. The field core magnetically attracts the armature to the driving rotating body. One end of each of the spring members is fixed to the armature. The other end of each of the spring members is held by the driven rotating body so as to be removed upon being applied with a tensile force.

### BACKGROUND OF THE INVENTION

The present invention relates to an electromagnetic clutch provided with a torque limiter mechanism.

U.S. Pat. No. 5,683,299 (literature 1), for example, describes a conventional electromagnetic clutch provided with a torque limiter mechanism. The torque limiter mechanism of the electromagnetic clutch disclosed in literature 1 adopts a configuration in which when an excessive load torque acts on the electromagnetic clutch, the armature of the electromagnetic clutch rotates relative to an armature hub to interrupt torque transmission.

The armature rotates integrally with the rotor of the electromagnetic clutch upon being magnetically attracted to this rotor. The rotor rotates upon receiving the power of a driving device (for example, an automobile engine), which is transmitted via a belt. The armature hub is mounted on the rotary shaft of a driven device (for example, a compressor for an air conditioner) to be rotatable integrally with it, and is connected to the armature via the torque limiter mechanism.

The torque limiter mechanism includes a first holder member provided to the armature, a second holder member provided to the armature hub, and a rubber elastic member interposed between the first and second holder members to be capable of power transmission. The first holder member engages with the elastic member from the exterior of the electromagnetic clutch in the radial direction, and the second holder member engages with the elastic member from the interior of the electromagnetic clutch in the radial direction. The engagement portion between the first and second holder members and the elastic member is configured such that one of the first and second holder members can move in the direction, in which the rotor rotates, relative to the other as the elastic member deforms elastically.

The engagement portion normally transmits a torque from the armature to the armature hub via the elastic member. However, when an excessive load torque is transmitted upon, for example, locking the driven device, the elastic member is compressed by elastic deformation of itself to cancel the engaged state of the engagement portion, and the armature rotates relative to the armature hub.

Also, when the compressor serving as the driven device is intermittently locked due to serious breakdown such as seizure, the state in which the holder members and the elastic member engage with each other and that in which this engagement is canceled as the elastic member deforms elastically, alternate. In this case, after the elastic member is rubbed against one holder member and compressed, its compressed state is canceled, and then it collides with the next holder member having moved with rotation of the armature, and thereby engages with the latter holder member. When the elastic member is repeatedly subjected to an impact and a strong frictional force in this manner, it is damaged due to fatigue. In other words, the torque limiter mechanism disclosed in literature 1 transmits power from the driving device to the driven device until the elastic member is damaged in this manner.

The electromagnetic clutch provided with the torque limiter mechanism disclosed in literature 1 cannot completely interrupt power transmission to the compressor unless the elastic member is damaged, as described above. That is, during the period from the generation of an excessive load until power transmission is interrupted as the elastic member is damaged, the belt continuously transmits the power of an automobile engine despite the intermittent stop of the rotor, and is therefore repeatedly subjected to an impact. At this time, the belt slips upon forcible rotation when the rotor is kept stopped. This results in abrasion of the belt due to slippage or its wear and tear.

### SUMMARY OF THE INVENTION

It is an object of the present invention to provide an electromagnetic clutch capable of preventing abrasion of a driving power transmission member such as a belt due to slippage and its wear and tear when an excessive load is generated in a driven device.

In order to achieve the above-mentioned object, according to the present invention, there is provided an electromagnetic clutch comprising a driving rotating body which receives power transmitted from a driving device via a driving power transmission member, a driven rotating body which is arranged coaxially with the driving rotating body, and mounted on a driven device to rotate integrally with the driven device, an armature which is opposed to an end face of the driving rotating body in an axial direction, and supported by the driven rotating body via spring members to integrally rotate with the driven rotating body, and a field core which magnetically attracts the armature to the driving rotating body, wherein one end of each of the spring members is fixed to the armature, and the other end of each of the spring members is held by the driven rotating body so as to be removed upon being applied with a tensile force having a magnitude that is not less than a predetermined magnitude.

### BRIEF DESCRIPTION OF THE DRAWINGS

FIG. 1 is a front view of an electromagnetic clutch according to the first embodiment of the present invention, in which an armature hub is partially cut away;

FIG. 2 is a sectional view taken along a line II-II in FIG. 1;

FIGS. 3A, 3B, and 3C are a front view showing a rotation transmission member shown in FIGS. 1 and 2, a side view showing this member in a natural state, and a side view showing this member in a mounted state;

FIG. 4 is a front view of a clamping plate shown in FIGS. 1 and 2;

FIG. 5A is a front view showing the state of the electromagnetic clutch, shown in FIG. 1, after power transmission interruption;

FIG. 5B is a sectional view taken along a line B-B in FIG. 5A;

FIG. 6 is a sectional view showing a holding member according to the second embodiment;

FIGS. 7A and 7B are sectional views showing a holding member according to the third embodiment; and

FIG. 8 is a sectional view showing a holding member according to the fourth embodiment.

### DESCRIPTION OF THE PREFERRED EMBODIMENTS

### First Embodiment

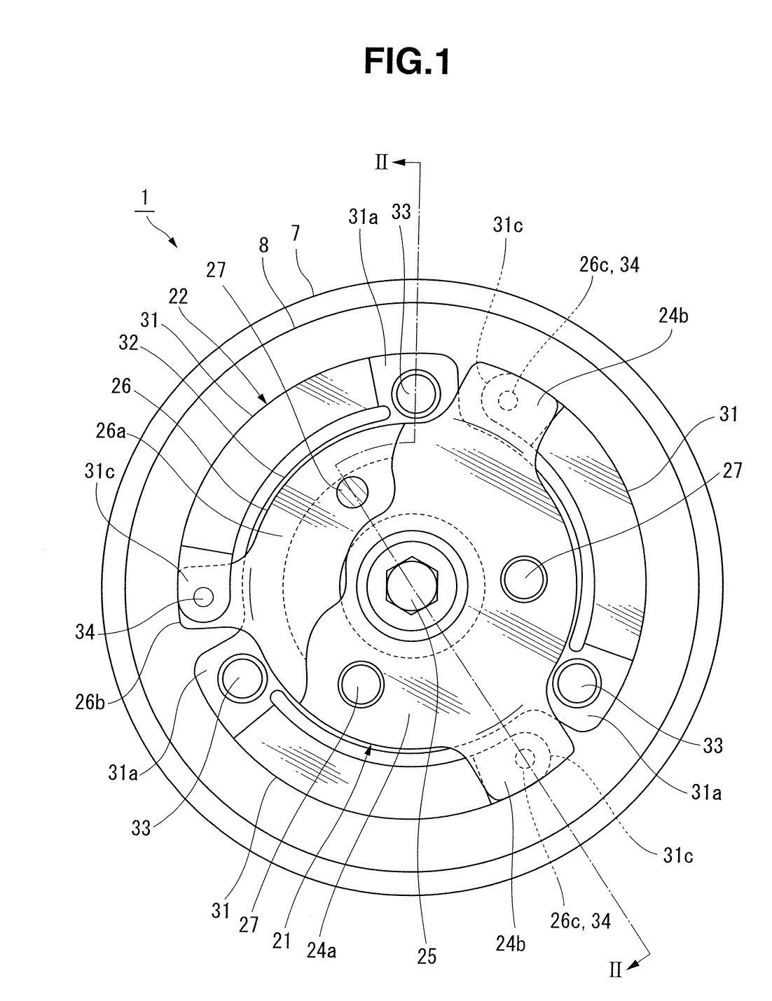

An electromagnetic clutch according to the first embodiment of the present invention will be described in detail below with reference to FIGS. 1 to 5B.

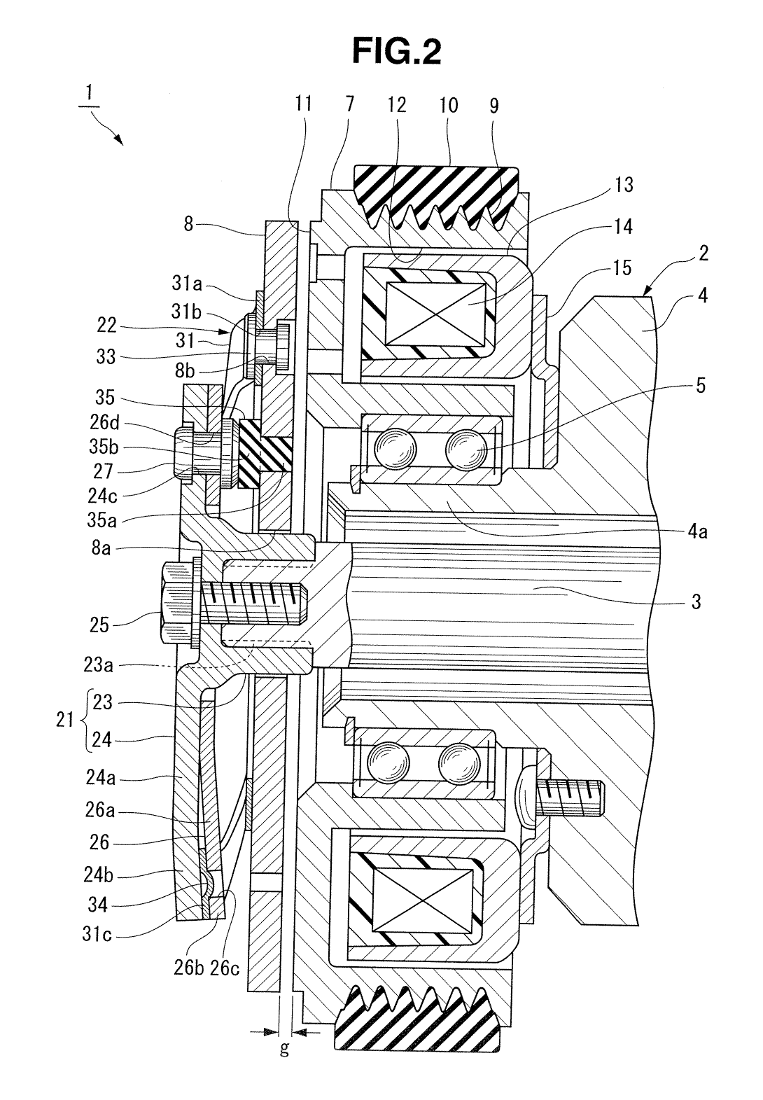

An electromagnetic clutch 1 shown in FIGS. 1 and 2 transmits power to a rotary shaft 3 of a compressor 2 for a car air conditioner (FIG. 2) or interrupts power transmission. The electromagnetic clutch 1 includes an annular rotor 7 (driving rotating body) rotatably supported on a cylindrical portion 4a of a front housing 4 of the compressor 2 by a bearing 5, and an armature 8 magnetically attracted to the rotor 7, as shown in FIG. 2.

The rotor 7 has a pulley groove 9 formed in its outer peripheral portion, and receives the power of an engine (not shown) serving as a driven device, which is transmitted via a belt 10 (driving power transmission member) wound around the pulley groove 9. The rotor 7 rotates clockwise in FIG. 1. The rotor 7 has a friction surface 11 formed as its one end face in the axial direction so as to be opposed to the armature 8 (to be described later).

The rotor 7 has an annular groove 12 formed in it to open on its other end face in the axial direction.

An annular field core 13 is inserted into the annular groove 12. The rotor 7 rotates while the field core 13 is inserted in the annular groove 12. The field core 13 includes an exciting coil 14, and is supported by the front housing 4 via a mounting plate 15. The field core 13 produces a magnetic flux to allow the rotor 7 to magnetically attract the armature 8 upon energizing the exciting coil 14.

The armature 8 is formed in an annular shape by a plate made of a magnetic material, and supported by an armature hub 21, which is mounted on the axial end of the rotary shaft 3, via a rotation transmission member 22 (to be described later), as shown in FIG. 2. The armature hub 21 includes a boss portion 23 (holding member) assembled together with the rotary shaft 3 by serration fitting so as to rotate integrally with each other, and an almost disk-shaped flange portion 24 extending from one end of the boss portion 23 radially outward.

The boss portion 23 has a cylindrical shape having serrations 23a formed on its inner peripheral portion, and is fixed to the rotary shaft 3 by a fixing bolt 25. The outer peripheral portion of the boss portion 23 is loosely fitted with an inner peripheral portion 8a of the armature 8.

The flange portion 24 includes a disk portion 24a, and three holding portions 24b protruding from the outer peripheral portion of the disk portion 24a radially outward, as shown in FIG. 1. The three holding portions 24b are disposed at positions at which the outer peripheral portion of the disk portion 24a is divided into three equal parts. The holding portions 24b are formed to be slightly tilted with respect to the disk portion 24a, as shown in FIG. 2. The direction in which the holding portions 24b are tilted is a direction to gradually come closer to the armature 8 toward the exterior of the disk portion 24a in the radial direction.

A clamping plate 26 formed to have an outer shape almost equal to that of the flange portion 24 is mounted on the flange portion 24 by three rivets 27. The clamping plate 26 and the armature hub 21 having the flange portion 24 constitute a driven rotating body. The clamping plate 26 is formed in a predetermined shape by a spring material. The clamping plate 26 includes an annular main body portion 26a, and three clamping portions 26b protruding from the outer peripheral portion of the main body portion 26a radially outward, as shown in FIG. 4.

The clamping portions 26b are provided at positions at which the outer peripheral portion of the main body portion 26a is divided into three equal parts. A circular through hole 26c is formed in each clamping portion 26b. The clamping plate 26 is fixed to the flange portion 24 while the three clamping portions 26b are positioned at the same positions as those of the holding portions 24b when viewed from the axial direction of the electromagnetic clutch 1, as shown in FIG. 1. Although details will be described later, the clamping plate 26 is mounted on the flange portion 24 while three spring members 31 of the rotation transmission member 22 (to be described later) are clamped between the holding portions 24b and the clamping portions 26b. Each rivet 27 is fastened upon being inserted into a through hole 26d (FIG. 4) formed in the main body portion 26a of the clamping plate 26, and a through hole 24c (FIG. 2) formed in the flange portion 24 of the armature hub 21.

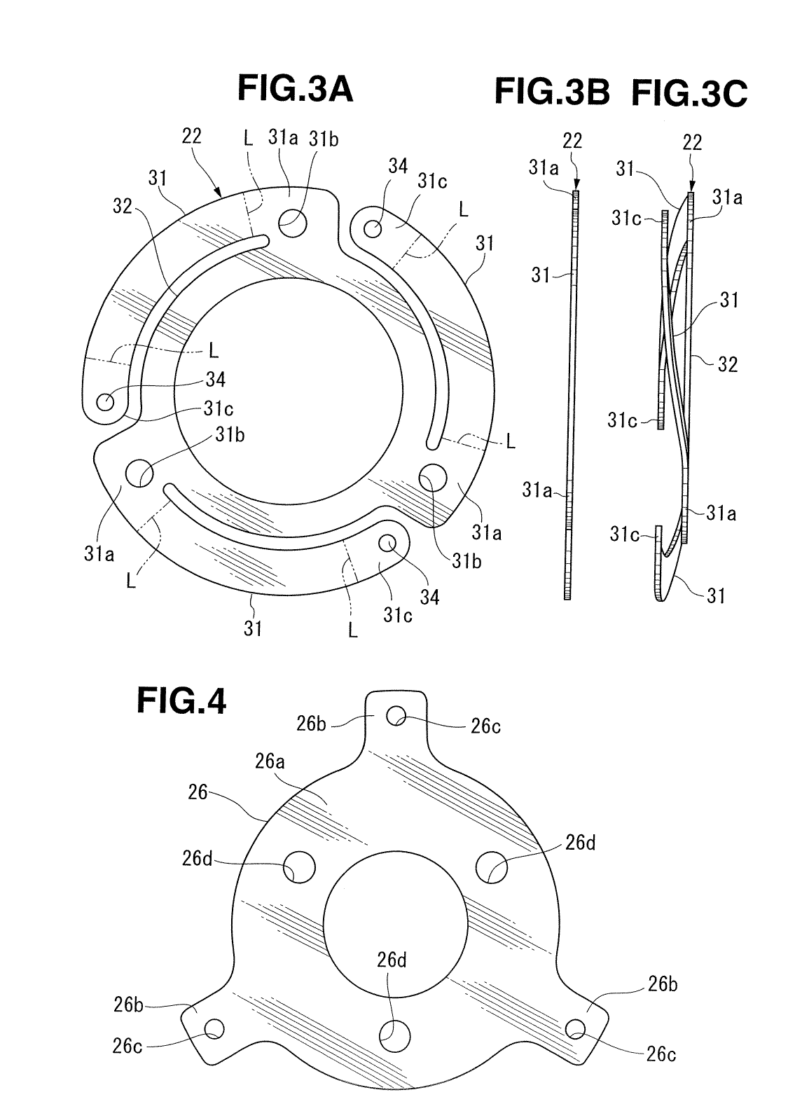

The rotation transmission member 22 is formed in an annular shape by stamping a thin plate made of a spring material into a predetermined shape. The rotation transmission member 22 includes the three spring members 31 formed in an arcuated shape, and an annular main body 32 disposed radially inside the three spring members 31, when viewed in a front view, as shown in FIGS. 1 and 3A. The spring members 31 are formed in an arcuated shape having the axial center of the rotary shaft 3 as its center, and are positioned to almost correspond to the holding portions 24b, respectively, of the armature hub 21 in the radial direction of the rotary shaft 3, as shown in FIG. 1.

One end (the end of the rotor 7 in the direction in which it rotates) of each spring member 31 is connected to a corresponding one of the positions at which the outer peripheral portion of the main body 32 is divided into three equal parts in the circumferential direction. Each spring member 31 extends along the peripheral edge of the main body 32 from its one end to its other end. Each spring member 31 is formed to have a length at which its other end overlaps the holding portion 24b of the armature hub 21 when viewed from the axial direction of the electromagnetic clutch 1, as shown in FIG. 1.

One end of each spring member 31, which is connected to the main body 32, is fixed to the armature 8 by a rivet 33, as shown in FIG. 2. This one end will be referred to as a fixing portion 31a hereinafter. The rivet 33 is inserted into a through hole 31b formed in the fixing portion 31a, and a through hole 8b formed in the armature 8. The other end of each spring member 31 has a semispherical protrusion 34 formed on it to engage with the through hole 26c in the clamping plate 26. This other end will be referred to as a connecting portion 31c hereinafter.

The connecting portions 31c of the spring members 31 are held by clamping between the holding portions 24b of the armature hub 21 and the clamping portions 26b of the clamping plate 26 while the protrusions 34 engage with the through holes 26c, as shown in FIG. 2. The clamping plate 26 elastically deforms upon insertion of the connecting portions 31c between the clamping portions 26b and the holding portions 24b. That is, in holding portions formed by the clamping portions 26b and holding portions 24b, the connecting portions 31c of the spring members 31 are pressed against the holding portions 24b by the spring force of the clamping plate 26, which acts on the clamping portions 26b. Also, a tensile force having a magnitude equal to or larger than a predetermined magnitude acts on the connecting portions 31c of the spring members 31, thereby canceling engagement between the protrusions 34 and the through holes 26c. Thus, the connecting portions 31c are pulled out and removed from the portions in which the armature hub 21 and the clamping plate 26 are connected to each other.

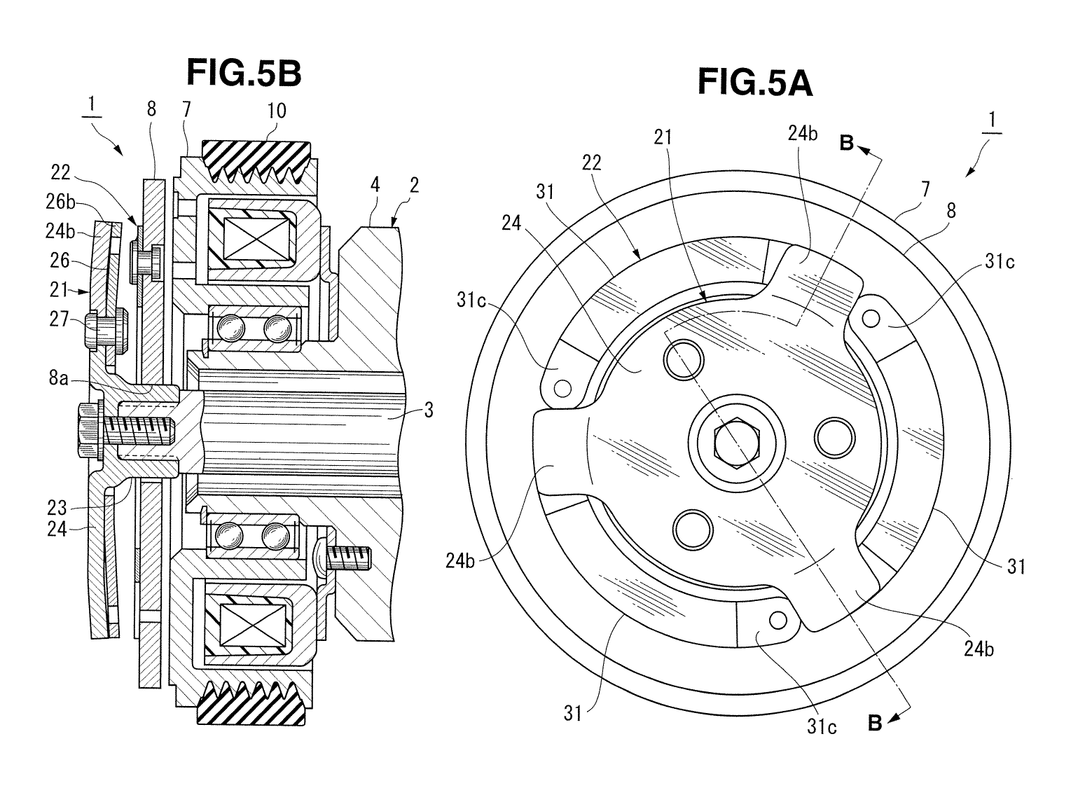

When the connecting portions 31c of the spring members 31 are removed from the armature hub 21 and clamping plate 26, supporting of the armature 8 by the rotation transmission member 22 is canceled, as shown in FIG. 5B. However, in this embodiment, the boss portion 23 of the armature hub 21 is loosely fitted with the inner peripheral portion 8a of the armature 8, and therefore holds the armature 8 in place of the rotation transmission member 22.

A pressing member 35 is provided between the armature 8 on which the fixing portions 31a of the spring members 31 are fixed, and the armature hub 21 which holds the connecting portions 31c of the spring members 31, as shown in FIG. 2. The pressing member 35 positions the armature 8 on the side of the rotor 7 relative to the flange portion 24 of the armature hub 21. Thus, the spring members 31 elastically deform to apply an initial load on the spring members 31. The spring members 31 shown in FIG. 2 elastically deform so that the fixing portions 31a are positioned in a direction to come closer to the rotor 7 than the connecting portions 31c. The spring members 31 are bent at positions indicated by alternate long and two short dashed lines L in FIG. 3A, and deform elastically, as shown in FIG. 3C.

The pressing member 35 includes a small-diameter portion 35a fixed to the armature 8 while being fitted with the through hole 8b in the armature 8, and a large-diameter portion 35b which is formed integrally with the small-diameter portion 35a and protrudes toward the flange portion 24 of the armature hub 21 from the armature 8. The pressing member 35 is made of rubber. Pressing members 35 are positioned in three portions opposed to the rivets 27, respectively, used to mount the clamping plate 26 on the armature hub 21. The large-diameter portions 35b of the pressing members 35 are pressed against the rivets 27 by the spring forces (elastic restoring forces) of the spring members 31, and thereby deform elastically. The axial length of the large-diameter portions 35b is set such that a predetermined air gap g is formed between the armature 8 and the friction surface 11 of the rotor 7 while the large-diameter portions 35b of the pressing members 35 deform elastically.

To assemble the above-mentioned electromagnetic clutch 1, first, the connecting portions 31c of the rotation transmission member 22 are held by the armature hub 21 and clamping plate 26 to support the armature 8 on the armature hub 21. To achieve this, first, the three connecting portions 31c are clamped by the three holding portions 24b of the armature hub 21 and the three clamping portions 26b of the clamping plate 26. Next, while sets of three members are stacked on each other in this way, the rivets 27 are fastened to fix the clamping plate 26 to the flange portion 24 of the armature hub 21. After the rivets 27 are fastened, the armature 8 is fixed to the fixing portions 31a of the rotation transmission member 22 by the rivets 33. At this time, the pressing members 35 are pressed against the rivets 27, thereby elastically deforming the spring members 31 of the rotation transmission member 22.

In the thus configured electromagnetic clutch 1, a magnetic flux is produced by the field core 13 upon energizing the exciting coil 14 so that a magnetic attractive force acts on the armature 8. As a result, the armature 8 moves to the rotor 7 against the spring forces of the spring members 31, and is thereby magnetically attracted to the rotor 7. In this state, rotation of the rotor 7 is transmitted from the armature 8 to the compressor 2 via the spring members 31 and armature hub 21.

In the above-mentioned power transmission state, if the magnetic flux of the field core 13 disappears, the armature 8 separates from the rotor 7 by the spring forces of the spring members 31, and thereby returns to the initial position. Thus, power transmission is interrupted in this initial state. On the other hand, if an excessive load is generated in the compressor 2 during power transmission, and the rotary shaft 3 therefore becomes hard to rotate or stops, a difference is generated between the rotational speed of the armature hub 21 and that of the armature 8, so an excessive tensile force acts on the connecting portions 31c of the spring members 31. When this tensile force gets stronger than a predetermined magnitude, the connecting portions 31c are pulled out and removed from the holding portions formed by the armature hub 21 and clamping plate 26, as shown in FIG. 5A.

That is, upon the generation of an excessive load, the connecting portions 31c of the spring members 31 are removed from the armature hub 21, thereby instantaneously interrupting power transmission. At this time, after the connecting portions 31c are removed from the holding portions formed by the armature hub 21 and clamping plate 26, the spring members 31 return to the side of the armature 8 by their self elasticity. Hence, although the spring members 31 rotate integrally with the rotor 7 and armature 8, they come into contact with neither the armature hub 21 nor the clamping plate 26.

According to this embodiment, since power transmission is instantaneously interrupted upon the generation of an excessive load, it is possible to reduce abrasion of the belt 10, wound around the pulley groove 9 in the rotor 7, due to slippage, and its wear and tear.

The electromagnetic clutch 1 according to this embodiment includes the pressing members 35 which elastically deform the spring members 31 so that the fixing portions 31a of the spring members 31 are positioned on the side of the rotor 7 relative to the connecting portions 31c. Hence, the armature 8 can be positioned to form the predetermined air gap g between itself and the rotor 7 while the spring members 31 elastically deform to a large extent. As a result, not only the spring members 31 can reliably return to the side of the armature 8 by elastic restoration upon the generation of an excessive load, but also the gap between the spring members 31 and the armature hub 21 and clamping plate 26 can be widened after the spring members 31 return by elastic restoration.

The electromagnetic clutch 1 according to this embodiment includes a holding member (the boss portion 23 of the armature hub 21) which holds the armature 8 while the connecting portions 31c of the spring members 31 are removed from the armature hub 21. Hence, even if the magnetic flux of the field core 13 disappears while the spring members 31 are removed from the holding portions formed by the armature hub 21 and clamping plate 26, the armature 8 can be supported by the boss portion 23, as shown in FIG. 5B. As a result, the armature 8 can be prevented from freely moving at a position adjacent to the rotor 7 and colliding with the rotor 7 and other members.

The holding member according to this embodiment is formed by a cylindrical body (boss portion 23) in which the armature 8 is loosely fitted with the axial center of the armature hub 21. Hence, components smaller in number than those required to provide a dedicated holding member suffice, thus reducing the cost of the electromagnetic clutch.

### Second Embodiment

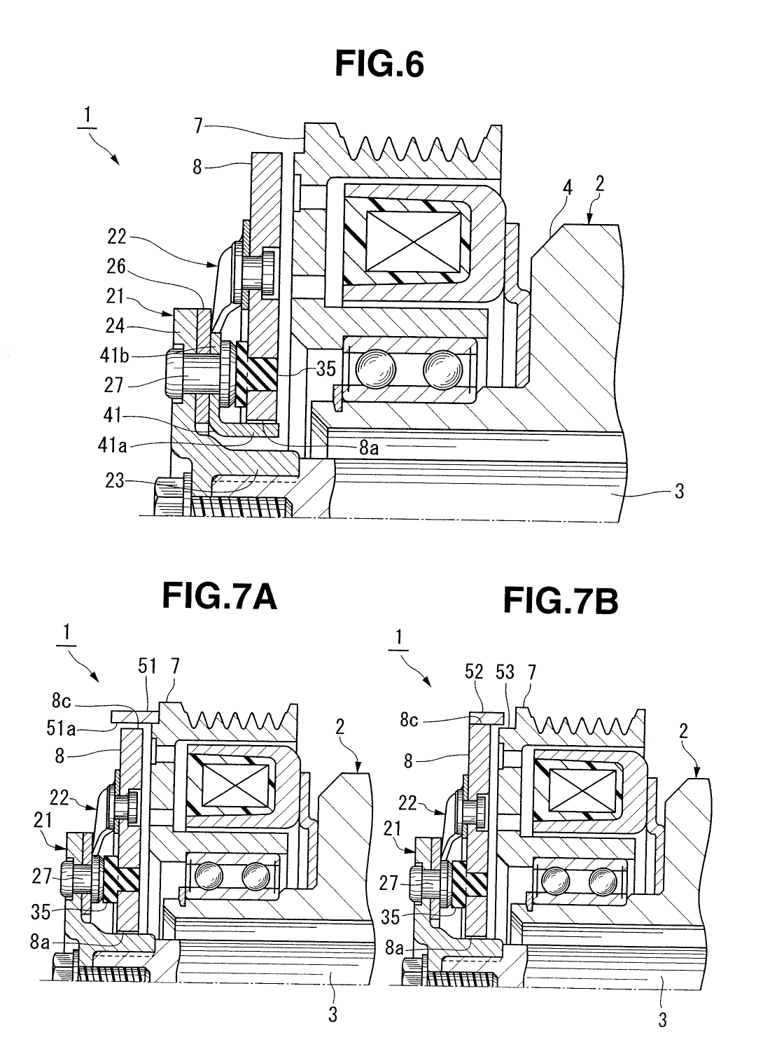

A holding member which supports an armature, supporting by a rotation transmission member of which is canceled, can also be configured as shown in FIG. 6. Referring to FIG. 6, the same reference numerals denote the same or equivalent members as or to the members described with reference to FIGS. 1 to 5B, and a detailed description thereof will not be given as needed. In an electromagnetic clutch 1 according to this embodiment, an armature 8 is formed to have an inner diameter larger than that in the first embodiment. Also, not only a clamping plate 26 but also a holding member 41 for supporting the armature 8 is mounted on an armature hub 21 by rivets 27.

The holding member 41 includes a cylindrical portion 41a loosely fitted with an inner peripheral portion 8a of the armature 8, and a disk portion 41b (mounting portion) used to mount the cylindrical portion 41a on the armature hub 21. The holding member 41 according to this embodiment can be formed in conformity with the shape (inner diameter) of the armature 8. Hence, no constraint is imposed on the inner diameter of the armature 8 in formation, so the freedom of design of the armature 8 improves.

### Third Embodiment

A holding member which holds an armature, supporting by a rotation transmission member of which is canceled, can also be configured as shown in FIGS. 7A and 7B. Referring to FIGS. 7A and 7B, the same reference numerals denote the same or equivalent members as or to the members described with reference to FIGS. 1 to 5B, and a detailed description thereof will not be given as needed.

Holding members 51 and 52 according to this embodiment protrude from the outer peripheral portion of one of a rotor 7 and an armature 8 so as to be opposed to the outer peripheral surface of the other. The holding member 51 shown in FIG. 7A is formed in a cylindrical shape having a size at which it is loosely fitted with the outer peripheral portion of the armature 8, and is welded to the outer peripheral portion of the rotor 7 to protrude toward the armature 8. An inner peripheral surface 51a of the holding member 51 is opposed to an outer peripheral surface 8c of the armature 8 while the armature 8 is not magnetically attracted to the rotor 7.

The holding member 52 shown in FIG. 7B is formed in a cylindrical shape which is loosely fitted with a peripheral surface 53, formed on the outer peripheral portion of the rotor 7, and is welded to the outer peripheral surface 8c of the armature 8. The inner peripheral surface of the holding member 52 is opposed to the peripheral surface 53 while the armature 8 is not magnetically attracted to the rotor 7. The armature 8 according to this embodiment is held by the rotor 7 via the holding members 51 and 52 after spring members 31 are removed from an armature hub 21. According to this embodiment, since the holding members 51 and 52 are arranged on the outermost side of an electromagnetic clutch 1, they can easily be equipped especially when the electromagnetic clutch 1 according to the present invention is to be configured by exploiting the existing electromagnetic clutch.

As in the electromagnetic clutch 1 shown in this embodiment, when a compressor for an automobile air conditioner serves as a driven device, the holding member 52 is provided on the armature 8, as shown in FIG. 7B. Alternatively, as shown in the first and second embodiments, the holding member 52 desirably adopts a configuration which holds an inner peripheral portion 8a of the armature 8. The adoption of such a configuration makes it possible to allow the rotor 7 serving as a driving rotating body to be relatively lightweight.

### Fourth Embodiment

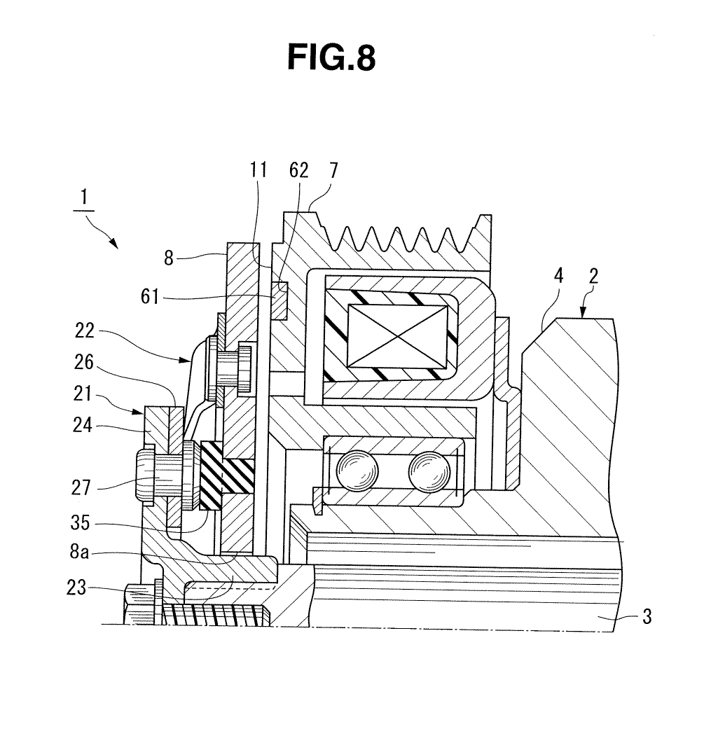

A holding member which holds an armature, supporting by a rotation transmission member of which is canceled, can also be configured as shown in FIG. 8. Referring to FIG. 8, the same reference numerals denote the same or equivalent members as or to the members described with reference to FIGS. 1 to 5B, and a detailed description thereof will not be given as needed.

A holding member 61 according to this embodiment is formed by a permanent magnet buried in a rotor 7. The holding member 61 made of a permanent magnet is formed in an annular shape, and is fixed while being inserted in an annular recess 62 formed in the rotor 7. The recess 62 is formed to open on a friction surface 11 of the rotor 7.

The magnetic attractive force of the holding member 61 is set to have a magnitude which cannot bring an armature 8 at a non-connection position into tight contact with the rotor 7 against the spring forces of spring members 31, and which can bring the armature 8 into tight contact with the rotor 7 and hold it while the spring members 31 are removed from an armature hub 21 upon the generation of an excessive load. Hence, the armature 8 is kept attracted to the rotor 7 even if the magnetic flux of a field core 13 disappears while the spring members 31 are removed from the armature hub 21. Since the holding member 61 according to this embodiment is buried in the rotor 7, a compact electromagnetic clutch can be designed.

As described above, in the electromagnetic clutch according to the present invention, a magnetic attractive force acts on the armature upon producing a magnetic flux by the field core, so the armature moves toward the driving rotating body against the spring forces of the spring members, and is thereby magnetically attracted to the driving rotating body. In this state, rotation of the driving rotating body is transmitted from the armature to the driven rotating body via the spring members. In this power transmission state, when the magnetic flux of the field core disappears, the armature separates from the driving rotating body by the spring forces of the spring members, and thereby returns to the initial position. Hence, in this state, power transmission is interrupted.

On the other hand, when an excessive load is generated in the driven device during power transmission, the armature rotates relative to the driven rotating body, so an excessive tensile force acts on the other end of each spring member. When this tensile force gets stronger than a predetermined magnitude, the other end of each spring member is pulled out and removed from the driven rotating body. Hence, upon the generation of an excessive load, the other end of each spring member is removed from the driven rotating body, thereby interrupting power transmission. The spring members return to the side of the armature by elastic restoration after they are removed from the driven rotating body. Hence, although the spring members rotate integrally with the driving rotating body and the armature, they do not come into contact with the driven rotating body.

Therefore, the present invention can provide an electromagnetic clutch capable of instantaneously interrupting power transmission upon the generation of an excessive load to reduce abrasion of a driving power transmission member due to slippage or its wear and tear.

What is claimed is:

1. An electromagnetic clutch comprising:
a driving rotating body which receives power transmitted from a driving device via a driving power transmission member;
a driven rotating body which is arranged coaxially with said driving rotating body, and mounted on a driven device to rotate integrally with the driven device;
an armature which is opposed to an end face of said driving rotating body in an axial direction, and supported by said driven rotating body via spring members to integrally rotate with said driven rotating body; and
a field core which magnetically attracts said armature to said driving rotating body,
wherein one end of each of said spring members is fixed to said armature, and
the other end of each of said spring members is held by said driven rotating body so as to be removed upon being applied with a tensile force having a magnitude that is not less than a predetermined magnitude.

2. A clutch according to claim 1, wherein a pressing member, which elastically deforms said spring members so that said one end of each of said spring members is positioned in a direction to come closer to said driving rotating body than said other end of each of said spring members, is provided between said armature and said driven rotating body.

3. A clutch according to claim 1, further comprising holding members which hold said armature while said other end of each of said spring members is removed from said driven rotating body.

4. A clutch according to claim 3, wherein said holding member is formed by a cylindrical body provided so that said armature is loosely fitted with an axial center of said driven rotating body.

5. A clutch according to claim 3, wherein
said armature is formed in an annular shape and arranged coaxially with said driven rotating body, and
said holding member is formed by a cylindrical portion loosely fitted with an inner peripheral portion of said armature, and a mounting portion used to mount said cylindrical portion on said driven rotating body.

6. A clutch according to claim 3, wherein said holding members protrude from an outer peripheral portion of one of said driving rotating body and said armature so as to be opposed to an outer peripheral surface of the other.

7. A clutch according to claim 3, wherein said holding member is formed by a permanent magnet which magnetically attracts said armature to said driving rotating body.

8. A clutch according to claim 1, wherein said pressing member is made of rubber.

9. A clutch according to claim 1, wherein said pressing member is fixed to said armature so as to be opposed to a plurality of rivets which mount said driven rotating body on said armature hub, and is pressed against said plurality of rivets by spring forces of said spring members.
